(19) United States
(12) Patent Application Publication
(10) Pub. No.: US 2015/0263349 A1
(43) Pub. Date: Sep. 17, 2015

(54) BATTERY

(71) Applicant: HONDA MOTOR CO., LTD., Tokyo (JP)

(72) Inventor: Hidehisa Mokudai, Wako-shi (JP)

(73) Assignee: HONDA MOTOR CO., LTD., Tokyo (JP)

(21) Appl. No.: 14/418,289

(22) PCT Filed: Aug. 1, 2013
(86) PCT No.: PCT/JP2013/070907

§ 371 Date: Jan. 29, 2015

(30) Foreign Application Priority Data
Aug. 2, 2012 (JP) 2012-172014

(51) Int. Cl. H01M 4/60; H01M 6/16; H01M 10/0568

(52) U.S. Cl. CPC H01M 4/60; H01M 10/0568; H01M 6/166; H01M 2004/028

(57) ABSTRACT

Provided is a battery having a higher charge-discharge capacity density than conventional batteries, and exhibiting excellent charge-discharge cycle properties and charge-discharge efficiency. This battery (1) is provided with a positive electrode (2), a negative electrode (3), and an electrolyte solution which lies between the positive electrode (2) and the negative electrode (3) and which comprises an electrolyte, the positive electrode (2) containing rubeanic acid or a rubeanic acid derivative as an active material, and the molar concentration of the electrolyte in the electrolytic solution being greater than 1.0 mol/L. This battery (1) has a large volume of anions originating from the electrolyte, and rubeanic acid or a rubeanic acid derivative can be used from the oxidant to reduced form thereof, thus it is possible to obtain a higher charge-discharge capacity density than conventional batteries, excellent charge-discharge cycle properties and excellent charge-discharge efficiency.

### TECHNICAL FIELD

The present invention relates to a battery containing rubeanic acid or a rubeanic acid derivative as the active material of the cathode.

### BACKGROUND ART

In recent years, lithium batteries have received attention as batteries of high energy density. It has been know that a lithium battery having a high voltage of 3 V or higher is obtained by using an electrolytic solution of a non-aqueous solution system. However, there has been a problem in that conventional lithium batteries have low capacity per mass of cathode material and anode material.

Therefore, the present applicants proposed a battery containing rubeanic acid (dithiooxamide) or a rubeanic acid derivative (hereinafter referred to as “rubeanic acid (derivative)”) as the active material of the cathode (refer to Patent Document 1). With this battery, as shown in formula (I) below, rubeanic acid (derivative) binds with lithium ion upon charging (reduction), and releases the lithium ion upon discharging (oxidation). The lithium ion is supplied from the anode side containing a carbon material or silicon-tin material into which lithium ions are incorporated, in addition to lithium metal. According to this battery, it is said that high capacity density is obtained even at room temperature or lower.

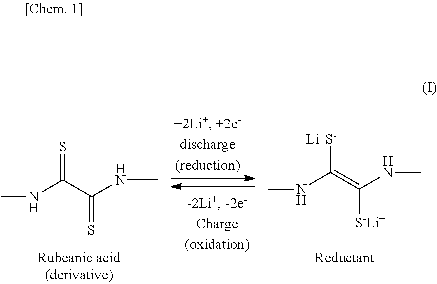

Patent Document 1: Japanese Unexamined Patent Application, Publication No. 2008-147015

### DISCLOSURE OF THE INVENTION

### Problems to be Solved by the Invention

However, even with the battery of Patent Document 1, it is not considered to have sufficient charge-discharge capacity density, and thus a further improvement in charge-discharge capacity density is demanded.

In addition, with the battery of Patent Document 1, the charge-discharge cycle properties and charge-discharge (coulomb) efficiency are not considered sufficient, and thus further improvements in charge-discharge cycle properties and charge-discharge efficiency are demanded.

The present invention has been made taking the above into account, and an object thereof is to provide a battery having higher charge-discharge capacity density compared to conventionally, as well as having superior charge-discharge cycle properties and charge-discharge efficiency.

### Means for Solving the Problems

In order to achieve the above-mentioned object, the present invention is a battery (e.g., the battery 1 described later) includes: a cathode (e.g., the cathode 2 described later), an anode (e.g., the anode 3 described later), and an electrolytic solution containing an electrolyte interposed between the cathode and the anode, in which the cathode comprises rubeanic acid or a rubeanic acid derivative as an active material; and a molar concentration of the electrolyte in the electrolytic solution is higher than 1.0 mol/L.

In the present invention, rubeanic acid (derivative) is used as the active material of the cathode, and the molar concentration of electrolyte in the electrolytic solution is set to higher than 1.0 mol/L. In other words, in the battery using rubeanic acid (derivative) as the active material of the cathode, the molar amount of anions derived from the electrolyte was increased, by raising the electrolyte concentration in the electrolytic solution higher than conventionally.

It is thereby possible to form the oxidant in which electrons are further extracted from the state of rubeanic acid (derivative), when charging (oxidation), due to the anions derived from electrolyte being abundantly present. In addition, during discharging (reduction), it is possible to discharge until the reductant is formed from this oxidant. Therefore, since rubeanic acid (derivative) can assume forms from oxidant to reductant, high charge-discharge capacity density compared to conventionally is obtained.

In addition, by raising the electrolyte concentration in the electrolytic solution more than conventionally, the amounts of cations (M⁺) and anions (A⁻) in the electrolyte solvated in the electrolytic solution increase. For this reason, the rubeanic acid (derivative) and the oxidant (rubeanic acid (derivative) cation) or reductant (rubeanic acid (derivative) anion) generated by this charging-discharging at the electrodes do not easily solvate in the electrolytic solution in which cations (M⁺) and anions (A⁻) of electrolyte are abundantly contained, and can suppress dissolution to the electrolytic solution.

In addition, when the electrolyte concentration in the electrolytic solution rises, since the viscosity of the electrolytic solution increases, dissolution of rubeanic acid (derivative) and the oxidant or reductant thereof is suppressed thereby.

Therefore, the rubeanic acid (derivative) can undergo the desired charge-discharge reaction in the electrodes by raising the electrolyte concentration in the electrolytic solution, a result of which the charge-discharge cycle properties and charge-discharge efficiency improve.

In this case, it is preferable for the molar concentration of the electrolyte in the electrolytic solution to be 1.5 to 4.7 mol/L.

In the present invention, the molar concentration of the electrolyte in the electrolytic solution is set to within the range of 1.5 to 4.7 mol/L. The aforementioned effects are thereby further enhanced.

In this case, it is preferable for the molar concentration of the electrolyte in the electrolytic solution to be 2.0 to 4.7 mol/L.

In the present invention, the molar concentration of the electrolyte in the electrolytic solution is set to within the range of 2.0 to 4.7 mol/L. The aforementioned effects are thereby even further enhanced.

In this case, it is preferable for the rubeanic acid or the rubeanic acid derivative to have a structural unit represented by formula (1) below.

[Chem. 2]

—(NR¹—CS—CS—NR²)— (1)

R¹ and R² in formula (1) each independently represent a hydrogen atom, a halogen atom, a saturated linear hydrocarbon group, an unsaturated linear hydrocarbon group, a saturated cyclic hydrocarbon group, an unsaturated cyclic hydrocarbon group, a saturated heterocyclic group, an unsaturated heterocyclic group, an aromatic hydrocarbon group, an aromatic heterocyclic group, a carbonyl group, a carboxyl group, an amino group, an amide group, a hydroxyl group, a sulfide group, a disulfide group or a sulfone group.

In addition, in this case, it is preferable for the rubeanic acid or the rubeanic acid derivative to be represented by formula (2) below.

[Chem. 3]

R³—(NR¹—CS—CS—NR²)n—R⁴ (2)

R¹, R², R³ and R⁴ in formula (2) each independently represent a hydrogen atom, a halogen atom, a saturated linear hydrocarbon group, an unsaturated linear hydrocarbon group, a saturated cyclic hydrocarbon group, an unsaturated cyclic hydrocarbon group, a saturated heterocyclic group, an unsaturated heterocyclic group, an aromatic hydrocarbon group, an aromatic heterocyclic group, a carbonyl group, a carboxyl group, an amino group, an amide group, a hydroxyl group, a sulfide group, a disulfide group or a sulfone group; and n represents an integer of at least 1.

In addition, in this case, it is preferable for the anion derived from the electrolyte to be at least one type selected from the group consisting of PF₆⁻, AsF₆⁻, BF₄⁻, Cl⁻, Br⁻, ClO₄⁻, CH₃SO₃⁻, CF₃SO₃⁻, C₄F₉SO₃⁻, (CF₃SO₂)₂N⁻ and (CF₃SO₂)₃C⁻.

According to the rubeanic acid (derivative) represented by formula (1) or (2) above, it assumes the form from oxidant to reductant as shown in formula (II) below. Therefore, high charge-discharge capacity is obtained compared to conventionally.

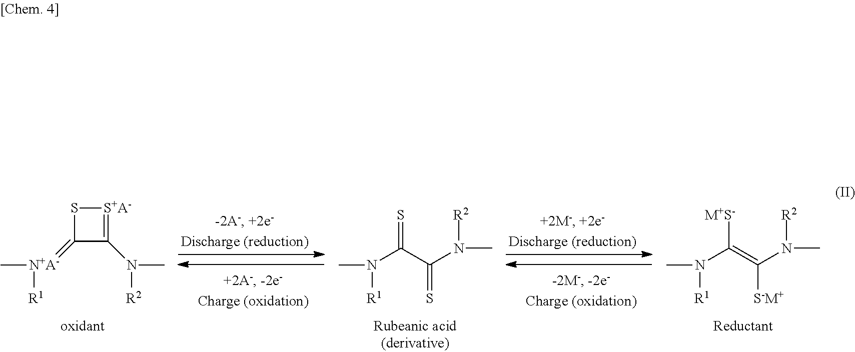

R¹ and R² in formula (II) above are the same as formula (1) or (2) above, and A⁻ represents the various anions exemplified above, and M⁺ represents at least type of metal cation selected from the group consisting of alkali metal cations including Li⁺, Na⁺ and K⁺, as well as divalent metal cations of periodic table group 2 elements including Be²⁺, Mg²⁺ and Ca²⁺.

### Effects of the Invention

According to the present invention, it is possible to provide a battery having high charge-discharge capacity compared to conventionally, as well as having superior charge-discharge cycle properties and charge-discharge efficiency.

### BRIEF DESCRIPTION OF THE DRAWINGS

FIG. 1 is a vertical cross-sectional view showing the configuration of a battery 1 according to an embodiment of the present invention;

FIG. 2 is a charge-discharge curve graph of a battery obtained in Example 1;

FIG. 3 is a charge-discharge curve graph of a battery obtained in Example 2;

FIG. 4 is a graph showing the relationship between the relative discharge capacity of Examples 3 to 6 and number of cycles, when defining the initial discharge capacity of Comparative Example 2 as 100; and

FIG. 5 is a graph showing the relationship between the charge-discharge efficiency (%) and the number of cycles of Examples 4 to 6 and Comparative Example 2

### PREFERRED MODE FOR CARRYING OUT THE INVENTION

Hereinafter, an embodiment of the present invention will be explained in detail while referencing the drawings.

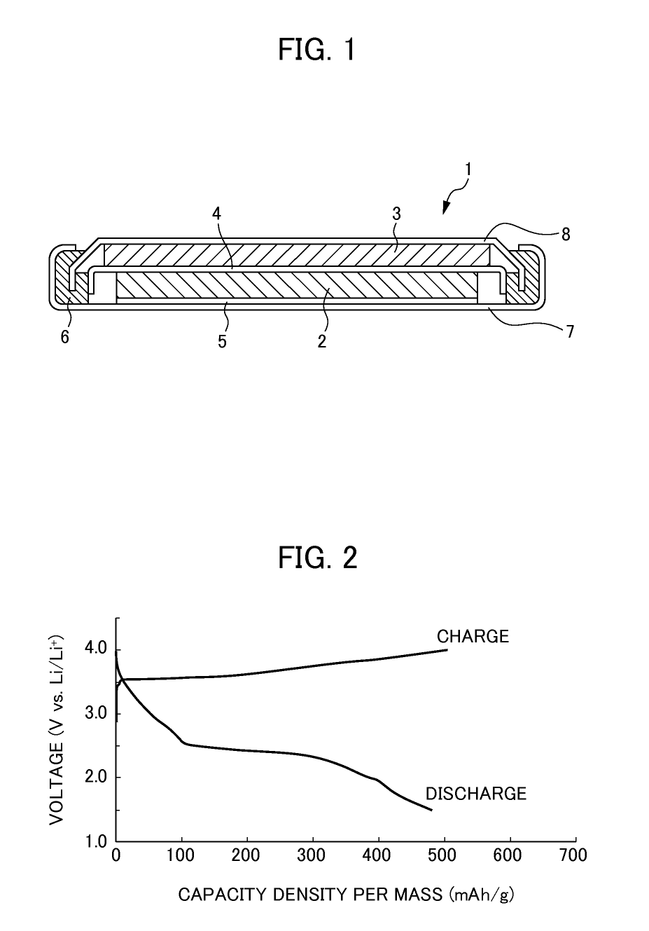

FIG. 1 is a vertical cross-sectional view showing the configuration of a battery 1 according to an embodiment of the present invention. It should be noted that, in the following explanation, when explaining the vertical direction, the explanation is based on up and down in FIG. 1.

As shown in FIG. 1, the battery 1 is a coin-type lithium battery in which the profile thereof is a disk shape, and corresponds to the CR2032 standard. The battery 1 includes a cathode can 7 arranged at a lower side, an anode can 8 arranged at an upper side, and therebetween includes a cathode 2 and anode 3 provided in order from the lower side.

Between the cathode 2 and anode 3, a separator 4 that separates both from each other is inserted. A current collector 5 is arranged between the cathode 2 and the cathode can 7, and the cathode can 7 and anode can 8 are electrically isolated by a gasket 6.

The cathode 2 contains rubeanic acid or a rubeanic acid derivative as the active material. Herein, “rubeanic acid derivative” means a compound containing rubeanic acid, and rubeanic acid polymers, etc. are also included.

The rubeanic acid (derivative) preferably has a structural unit represented by the following formula (1).

[Chem. 5]

—(NR¹—CS—CS—NR²)— (1)

In formula (1), R¹ and R² each individually represent a hydrogen atom, a halogen atom, a saturated linear hydrocarbon group, an unsaturated linear hydrocarbon group, a saturated cyclic hydrocarbon group, an unsaturated cyclic hydrocarbon group, a saturated heterocyclic group, an unsaturated heterocyclic group, an aromatic hydrocarbon group, an aromatic heterocyclic group, a carbonyl group, a carboxyl group, an amino group, an amide group, a hydroxyl group, a sulfide group, a disulfide group or a sulfone group.

In addition, the rubeanic acid (derivative) is preferably represented by the following formula (2).

[Chem. 6]

R³—(NR¹—CS—CS—NR²)n—R⁴ (2)

In formula (2), R¹, R², R³ and R⁴ each individually represent a hydrogen atom, a halogen atom, a saturated linear hydrocarbon group, an unsaturated linear hydrocarbon group, a saturated cyclic hydrocarbon group, an unsaturated cyclic hydrocarbon group, a saturated heterocyclic group, an unsaturated heterocyclic group, an aromatic hydrocarbon group, an aromatic heterocyclic group, a carbonyl group, a carboxyl group, an amino group, an amide group, a hydroxyl group, a sulfide group, a disulfide group or a sulfone group; and n represents an integer of at least 1.

In the present embodiment, the rubeanic acid (NH₂—CS—CS—NH₂) is particularly preferable. Rubeanic acid itself does not have conductivity.

The rubeanic acid (derivative) may contain lithium (lithium ion) in a form reduced beforehand, as described later.

The cathode 2 preferably contains a conductive auxiliary and a binder.

As the conductive auxiliary, for example, carbon materials such as acetylene black, ketjenblack, graphite, and scaly graphite; metal powders such as nickel powder, titanium powder, silver powder and tungsten power; and conductive polymeric compounds such as polyaniline, polypyrrole and polyacetylene can be exemplified.

As the binder, for example, polytetrafluoroethylene, polyvinylidene fluoride, and the like can be exemplified.

In addition, the cathode 2 may contain the electrolyte described later, and may contain other active materials besides the rubeanic acid (derivative).

As other active materials, they are not particularly limited so long as able to store and release lithium ions. For example, those containing lithium ions such as lithium salts can be exemplified, and thereamong, lithium transition metal composite oxides are preferable.

As the lithium transition metal composite oxide, for example, lithium cobalt oxide, lithium nickel oxide, lithium manganese oxide, lithium nickel-cobalt-manganese oxide, and the like can be exemplified.

The content ratio of rubeanic acid (derivative) contained in the cathode 2 is preferably 1 to 100% by mass, and is more preferably 50 to 100% by mass.

The anode 3 contains an active material that can store (incorporate) and release (desorb) lithium ion.

As the active material, those containing lithium element (for example, lithium atom, lithium metal, lithium ion, lithium salt), and those not containing lithium element can be exemplified.

As those containing lithium element, for example, other than metallic lithium (including lithium alloys containing aluminum, etc.), lithium nitrides such as Li_{2.4}Co_{0.6}N and lithium oxides such as lithium titanate, etc. can be exemplified.

As those not containing lithium element, for example, graphite materials such as mesocarbon microbeads (MCMB); products of combusting and carbonizing phenol resin, pitch, etc.; carbon-based materials such as activated charcoal and graphite; silicon-based materials such as SiO and SiO₂; tin-based materials such as SnO and SnO₂; lead-based materials such as PbO and PbO₂; germanium-based materials such as GeO and GeO₂; phosphorus-based materials; niobium-based materials; antimony-based materials; and mixtures of these materials can be exemplified.

The anode 3 may include the aforementioned conductive auxiliary and binder.

As the anode 3, in the case of lithium element not being contained in the cathode 2, for example, one containing metallic lithium can be used, and in the case of lithium element (lithium ion, etc.) being contained in the cathode 2, although one containing lithium element is also used, one in which lithium element is not contained can be used.

It should be noted that the non-aqueous solution system battery free of lithium element in the cathode 2 and containing metallic lithium in the anode 3 can also be made to function as a primary battery.

As the separator 4, a sheet made of resin containing the electrolytic solution described later, and a gel-like material and solid material containing the electrolyte described later can be exemplified.

As the resin forming the sheet made of resin, it may be a conventional, known one, and a polyolefinic resin can be exemplified, for example. As the matrix resin of the separator 4 consisting of a solid material containing electrolyte, for example, a polyethylene oxide-based polymer, borate ester-based polymer, etc. can be exemplified.

The gel-like material and solid material can be used by molding into a plate shape. By using a gel-like material and solid material as the separator 4, the rubeanic acid (derivative) contained in the cathode 2 is avoided from eluting into the electrolytic solution over time, and degradation of the battery 1 is suppressed.

As the electrolytic solution, one produced by causing an electrolyte to dissolve in a solvent can be employed.

As the electrolyte, for example, it is preferably at least one type selected from the group consisting of LiPF₆, LiAsF₆, LiBF₄, LiCl, LiBr, LiClO₄, LiCH₃SO₃, LiCF₃SO₃, LiC₄F₉SO₃, LiN(CF₃SO₂)₂ and LiC(CF₃SO₂)₃.

According to these electrolytes, PF₆⁻, AsF₆⁻, BF₄⁻, Cl⁻, Br⁻, ClO₄⁻, CH₃SO₃⁻, CF₃SO₃⁻, C₄F₉SO₃⁻, (CF₃SO₂)₂N⁻, (CF₃SO₂)₃C⁻ are supplied as anions derived from electrolyte.

As the solvent dissolving the electrolyte, for example, carbonic ester (carbonate)-based solvents such as ethylene carbonate, propylene carbonate, dimethyl carbonate, methylethyl carbonate and diethyl carbonate; ester (also including cyclic esters)-based solvents such as methyl propionate, ethyl propionate and γ-butyrolactone; ether-based solvents such as monoglyme (ethylene glycol dimethyl ether), diglyme (diethylene glycol dimethyl ether), triglyme (triethylene glycol dimethyl ether), tetraglyme (tetraethylene glycol dimethyl ether); and mixed solvents of these can be exemplified.

The molar concentration of electrolyte in the electrolytic solution is set to a higher concentration than 1.0 mol/L. By setting in this way, anions derived from the electrolyte are abundantly present, and the rubeanic acid (derivative) can assume the form from an oxidant to a reductant.

More preferably, the molar concentration of electrolyte in the electrolytic solution is set within the range of 1.5 to 4.7 mol/L, and more preferably is set within the range of 2.0 to 4.7 mol/L.

Next, operation of the battery 1 of the present embodiment will be explained. More specifically, the redox reaction of the rubeanic acid (derivative) contained in the cathode 2 of the battery 1 having the anode 3 containing metallic lithium will be explained.

With the battery 1, the rubeanic acid (derivative) contained in the cathode 2 reversibly changes to the oxidant and reductant shown in the following formula (II). Herein, R¹, R², A⁻ and M⁺ in the following formula (II) are as mentioned above.

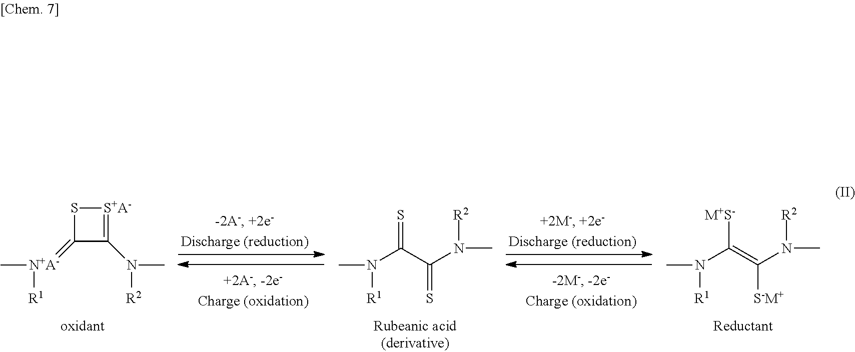

First, in the initial state in which neither of charging and discharging is being performed, the rubeanic acid (derivative) in the center of the above formula (II) changes to the reductant on the right side during discharging (reduction).

At this time, an electron (e⁻) is produced by the metallic lithium (Li) of the anode 3 becoming a lithium ion (Li⁺), and is supplied to the cathode 2 via the cathode can 7 and the current collector 5. In addition, the lithium ion (Li⁺) is supplied to the cathode 2 via the electrolyte contained in the separator 4.

It should be noted that, in the case of the cathode 2 containing lithium, and the anode 3 being a lithium-free compound (for example, graphite), immediately after assembling the battery 1 is a discharged state, and the rubeanic acid (derivative) exists as a reductant on the right side in the above formula (II). For this reason, when starting from charging (oxidation), the reductant on the right side of the above formula (II) changes to the rubeanic acid (derivative) in the center.

At this time, an electron (e⁻) is produced simultaneously with a Li ion (Li⁺) in the reductant desorbing on the cathode 2. The desorbed lithium ion (Li⁺) heads towards the anode 3 via the electrolyte contained in the separator 4, as well as becoming metallic lithium (Li) and depositing on the anode 3, by donating an electron (e⁻). In addition, the produced electron (e⁻) is supplied to the anode 3 via the cathode can 7, load and anode can 8. Then, at the anode 3, one lithium is incorporated by accepting and withdrawing one r electron by a 6 carbon group taking the form of a hexagon.

Furthermore, after changing to the rubeanic acid (derivative) at the center, it changes to the oxidant on the left side.

At this time, the rubeanic acid (derivative) releases an electron (e⁻) at the cathode 2, and an anion (A⁻) from the electrolyte contained in the separator 4 is supplied to the cathode 2. The released electron (e⁻) is supplied to the anode 3 via the cathode can 7, load and anode can 8.

Next, when discharging is started, it changes from the oxidant on the left side to the rubeanic acid (derivative) in the center.

At this time, an electron (e⁻) is produced by metallic lithium (Li) of the anode 3 becoming lithium ion (Li⁺), and is supplied to the cathode 2 via the anode can 8, cathode can 7 and current collector 5. In addition, the anion (A⁻) is released, and supplied to the electrolyte contained in the separator 4.

Then, discharge progresses further, and it changes from the rubeanic acid (derivative) in the center to the reductant on the right side. The battery 1 operates in the above way.

Herein, in the case of the rubeanic acid (derivative) releasing an electron to form the oxidant, only the counter anion A⁻ for canceling out the plus electrical charge of the rubeanic acid (derivative) exists in the electrolytic solution. In addition, in the initial charge and discharge, the solid electrolyte membrane referred to as SEI (Solid Electrolyte Interface) having a function of suppressing degradation of the electrolytic solution and electrodes is formed on the surface of the electrodes; however, anions in the electrolytic solution are also consumed upon formation of this membrane. For this reason, in a conventional battery, it is not possible to form oxidant of the rubeanic acid (derivative) during charging (oxidation).

In contrast, with the battery 1 of the present embodiment as mentioned above, the molar concentration of electrolyte in the electrolytic solution is set to a higher concentration than 1.0 mol/L, and thus the amount of anions derived from the electrolyte are present in abundance compared to conventionally. It is thereby configured so that the rubeanic acid (derivative) can assume three states from oxidant to reductant. By setting the molar concentration of electrolyte in the electrolytic solution to within the range of 1.5 to 4.7 mol/L, the trend thereof becomes more remarkable, and by setting to within the range of 2.0 to 4.7 mol/L, the trend thereof becomes even more remarkable.

Next, a production method of the battery 1 of the present embodiment will be explained. It should be noted that a first production method for a case of containing metallic lithium in the anode 3 and a second production method for a case of not containing metallic lithium in the anode 3 will be explained separately.

The first production method will be explained.

First, after kneading the rubeanic acid (derivative), conductive auxiliary and binder, the kneading product is spread into sheet form, and this is punched out into a predetermined shape, thereby forming the cathode 2.

In addition, a foil containing metallic lithium such as lithium or lithium alloy is punched out into a predetermined shape, thereby forming the anode 3.

Next, the cathode 2 is arranged via the current collector 5 at the bottom of the cathode can 7, and the separator 4 is arranged on the cathode 2. The separator 4 forms by causing the electrolytic solution to impregnate a porous resin sheet arranged on the cathode 2, for example. In addition, the separator 4 can be formed by arranging a gel-like material or solid material containing the electrolyte on the cathode 2.

Next, the anode 3 is arranged on the separator 4, along with the anode can 8 being arranged on this anode 3. At this time, the gasket 6 is arranged in order to electrically isolate the cathode can 7 and anode can 8. Then, the peripheral edge of the cathode can 7 is crimped, and the cathode can 7 and anode can 8 are joined via the gasket 6. The battery 1 is thereby produced.

The second production method will be explained.

First, an electrode body containing the rubeanic acid (derivative) is prepared. In this step, the electrode body is prepared similarly to the step of forming the anode 2 in the first production method.

Next, the lithium (lithium ion) is occluded to the obtained electrode body to prepare a first electrode. This first electrode can be obtained by reducing the rubeanic acid (derivative) contained in the electrode body to cause to change to the reductant, as well as causing lithium ion to bind to this. As such a first electrode, for example, after discharging the battery 1 obtained by the first production method, the cathode 2 removed from this battery 1 can be used.

On the other hand, a second electrode is prepared from an electrode material not containing metallic lithium that is an active material capable of occlusion and release of lithium ion. This second electrode is produced by spreading a kneading product containing the active material for the anode such as the aforementioned graphite material, carbon-based material and metal oxide, binder and, as necessary, conductive auxiliary into a sheet form, and then punching out into a predetermined shape.

Next, the battery 1 is produced through a process of incorporating the first electrode as the cathode 2, and incorporating the second electrode as the anode 3. As this process, other than using the first electrode and the second electrode as the cathode 2 and anode 3, a process of assembling the current collector 5, cathode 2, separator 4 and anode can 8 in this order to the cathode can 7 can be adopted, similarly to the first production method.

An anode 3 not containing metallic lithium, which is highly reactive, can be used in the above such second production method.

The following effects are exerted according to the battery 1 of the present embodiment.

In the present embodiment, rubeanic acid (derivative) is used as the active material of the cathode 2, and the molar concentration of electrolyte in the electrolytic solution is set to higher than 1.0 mol/L. In other words, in the battery 1 using rubeanic acid (derivative) as the active material of the cathode 2, the molar amount of anions derived from the electrolyte was increased, by raising the electrolyte concentration in the electrolytic solution higher than conventionally.

It is thereby possible to form the oxidant in which electrons are further extracted from the state of rubeanic acid (derivative), when charging (oxidation), due to the anions derived from electrolyte being abundantly present. In addition, during discharging (reduction), it is possible to discharge until the reductant is formed from this oxidant. Therefore, since rubeanic acid (derivative) can assume forms from oxidant to reductant, high charge-discharge capacity density compared to conventionally is obtained.

In addition, by raising the electrolyte concentration in the electrolytic solution more than conventionally, the amounts of cations (M⁺) and anions (A⁻) in the electrolyte solvated in the electrolytic solution increase. For this reason, the rubeanic acid (derivative) and the oxidant (rubeanic acid (derivative) cation) or reductant (rubeanic acid (derivative) anion) generated by this charging-discharging at the electrodes do not easily solvate in the electrolytic solution in which cations (M⁺) and anions (A⁻) of electrolyte are abundantly contained, and can suppress dissolution to the electrolytic solution.

In addition, when the electrolyte concentration in the electrolytic solution rises, since the viscosity of the electrolytic solution increases, dissolution of rubeanic acid (derivative) and the oxidant or reductant thereof is suppressed thereby.

Therefore, the rubeanic acid (derivative) can undergo the desired charge-discharge reaction in the electrodes by raising the electrolyte concentration in the electrolytic solution, a result of which the charge-discharge cycle properties and charge-discharge efficiency improve.

In addition, with the present embodiment, by setting the molar concentration of electrolyte in the electrolytic solution to within the range of 1.5 to 4.7 mol/L, the aforementioned effects are further enhanced.

Furthermore, in the present embodiment, by setting the molar concentration of electrolyte in the electrolytic solution to within the range of 2.0 to 4.7 mol/L, the aforementioned effects are even further enhanced.

The battery 1 of the present embodiment can be applied to either one of a non-aqueous solution-system primary battery and a non-aqueous solution-system secondary battery. The non-aqueous solution-system primary battery, for example, can be employed in the power source for a wristwatch, the power source for a small music-playback device, and the power source of small electronic devices such as the backup of a personal computer, etc. In addition, the non-aqueous solution-system secondary battery can be employed in mobile devices such as mobile telephones and digital cameras, as well as the power source for moving bodies like electric vehicles, and bipedal walking robots.

It should be noted that the present invention is not to be limited to the above-mentioned embodiment, and that modifications and improvements within a scope that can achieve the object of the present invention are included in the present invention.

In the above-mentioned embodiment, a coin-shaped lithium battery was applied as the battery 1; however, it is not limited thereto. For example, it may be applied to a square-type, cylindrical-type or paper-type battery.

### EXAMPLES

Next, although the present invention will be explained in further detail based on examples, the present invention is not to be limited thereto.

### Example 1

### Preparation of Cathode

First, sorting of at least 99% purity rubeanic acid (“D0957” manufactured by Tokyo Chemical Industry Co., Ltd.) was performed to prepare 5 grams of rubeanic acid powder consisting of 5 to 40 μm particle size.

Next, 4 g of vapor-phase grown carbon fiber (“VGCF (registered trademark)” manufactured by Showa Denko K.K.) as the conductive auxiliary, 0.5 g of polytetrafluoroethylene (“6-J” manufactured by Du Pont-Mitsui Fluorochemicals Co., Ltd.) as the binder, and 0.5 g of the rubeanic acid powder prepared above were sufficiently stirred with a small-scale V mixer. After stirring, the kneading product was prepared by kneading in an automatic mortar.

Next, the prepared kneading product was molded into sheet form of 0.3 mm thickness, and then a disk obtained by punching out this with a 14-mm diameter punch and a circular net made from pure titanium with a diameter of 15 mm (manufactured by Hokuto Denko Corp.) were superimposed, and pressed with a hydraulic press. A cathode in which the disk and net were integrated was thereby obtained.

The obtained cathode was vacuum dried for 16 hours at 80° C., and then kept inside of a glove box at the dew point of no more than −70° C. in which argon gas circulated.

(Preparation of Battery)

Using a member for a coin-type battery (manufactured by Hohsen Corp.) corresponding to the CR2032 standard, a non-aqueous solution system coin-type battery was prepared. The cathode prepared as described above was used as the cathode, and a circular metallic lithium foil (0.2 mm thickness, 16 mm diameter) with 99.95% purity was used as the anode. In addition, as the separator, using one produced by vacuum drying a disk (30 μm thickness, 20 mm diameter) consisting of a polyolefinic porous film (“HIPORE (registered trademark)” manufactured by Asahi Kasei Corp.) at 60° C. for 24 hr, 200 μL of a precursor solution of the following polymer gel electrolyte was injected and allowed to impregnate into this separator.

As preparation of the precursor solution of the polymer gel electrolyte, first, into a mixed solvent prepared by mixing ethylene carbonate and diethylcarbonate in a volume ratio of 3:7, a commercially available electrolytic solution (“LBG-94913” manufactured by Kishida Chemical Co., Ltd.) dissolving 1.0 mol/L of LiPF₆ and LiPF₆ (“LBG-45864” manufactured by Kishida Chemical Co., Ltd.) were added to prepare an electrolytic solution with a molar concentration of LiPF₆ of 1.8 mol/L.

Next, 3 parts by mass of a acrylate-based polymer solution having a substituent crosslinking by heating was added to 97 parts by mass of the prepared electrolytic solution, and was agitation mixed for 15 minutes under room temperature, thereby preparing the precursor solution of the polymer gel electrolyte.

Finally, a coin-type battery prepared by impregnating the precursor solution of polymer gel electrolyte was heated for 30 minutes in a thermostatic oven at 80° C. The precursor solution of polymer gel electrolyte thereby gelled to obtain the coin-type battery of a non-aqueous solution system having a polymer gel electrolyte.

### Example 2

Except for the preparation method of the precursor solution of polymer gel electrolyte differing from Example 1, a coin-type battery of a non-aqueous solution system having a polymer gel electrolyte was prepared by performing the same operations as Example 1.

As preparation of the precursor solution of the polymer gel electrolyte, first, into a mixed solvent prepared by mixing ethylene carbonate and diethylcarbonate in a volume ratio of 3:7, a commercially available electrolytic solution (“LBG-94913” manufactured by Kishida Chemical Co., Ltd.) dissolving 1.0 mol/L of LiPF₆ and LiPF₆ (“LBG-45864” manufactured by Kishida Chemical Co., Ltd.) were added to prepare an electrolytic solution with a molar concentration of LiPF₆ of 1.5 mol/L.

Next, 3 parts by mass of acrylate-based polymer solution having a substituent crosslinking by heating was added to 97 parts by mass of the prepared electrolytic solution, and was agitation mixed for 15 minutes under room temperature, thereby preparing the precursor solution of the polymer gel electrolyte.

### Comparative Example 1

A coin-type battery of a non-aqueous solution system having polymer gel electrolyte was obtained by performing the same operations as Example 1, except for the method of preparing the precursor solution of the polymer gel electrolyte differing from Example 1.

As preparation of the precursor solution of the polymer gel electrolyte, first, into a mixed solvent prepared by mixing ethylene carbonate and diethylcarbonate in a volume ratio of 3:7, a commercially available electrolytic solution (“LBG-94913” manufactured by Kishida Chemical Co., Ltd.) dissolving 1.0 mol/L of LiPF₆ was used as is.

Next, 3 parts by mass of acrylate-based polymer solution having a substituent crosslinking by heating was added to 97 parts by mass of the above-mentioned commercially available electrolytic solution, and was agitation mixed for 15 minutes under room temperature, thereby preparing the precursor solution of the polymer gel electrolyte.

### Charge-Discharge Test

Charge-discharge tests were conducted on the batteries obtained in Example 1 and 2 and Comparative Example 1. The charge-discharge test was conducted after leaving each battery to stand for 1 hr at room temperature immediately after preparation. More specifically, inside a thermostatic bath maintained at 25° C.±2° C., the voltage (potential difference between cathode and anode), which changed over time when discharging after charging at a constant current of 0.1 mA, was measured.

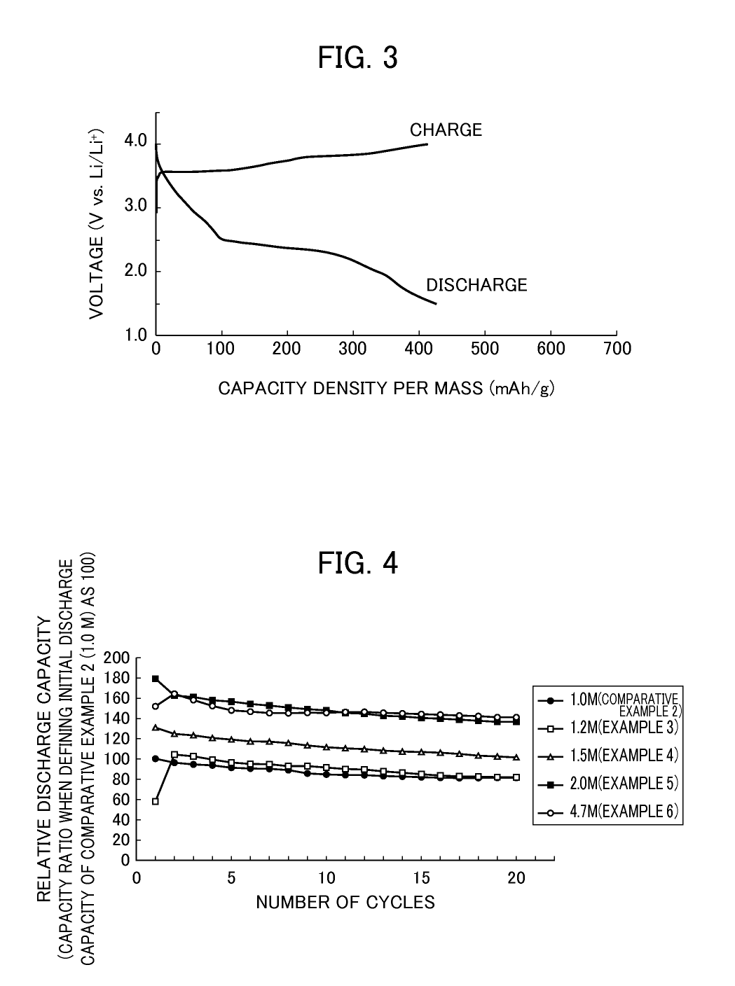

The charge-discharge curve of Example 1 is shown in FIG. 2, and the charge-discharge curve of Example 2 is shown in FIG. 3. In addition, the electrolyte concentration and charge-discharge test results of Examples 1 and 2 and Comparative Example 1 are summarized in Table 1.

TABLE 1

| | Electrolyte | Discharge capacity |
|---|---|---|
| | concentration (mol/L) | density (mAh/g) |
| Example 1 | 1.8 | 478.8 |
| Example 2 | 1.5 | 424.5 |
| Comparative | 1.0 | 422.9 |
| Example 1 | | |

In FIGS. 2 and 3, the vertical axis represents voltage (V), and the horizontal axis indicates the capacity density (mAh/g) per mass of cathode active material (rubeanic acid). From FIGS. 2 and 3, it is found that Example 1 and Example 2 have higher discharge capacity density compared to Comparative Example 1, and the discharge capacity density of Example 1 is particularly high.

It was confirmed from the above results that, as shown in Table 1, the battery of Example 1 and the battery of Example 2 having electrolyte concentrations in the electrolytic solution higher than 1.0 mol/L have higher charge-discharge capacity density compared to the battery of Comparative Example 1, in which the electrolyte concentration in the electrolytic solution is 1.0 mol/L. Herein, with the battery of Comparative Example 1 corresponding to a battery disclosed in Patent Document 1, it was confirmed that it is possible according to the present invention to provide a battery having higher charge-discharge capacity density compared to conventionally.

### Example 3

Except for the preparation method of the electrolytic solution differing from Example 1, a coin-type battery of a non-aqueous solution system was obtained by performing the same operations as Example 1.

More specifically, an electrolytic solution prepared by dissolving 1.2 mol/L of lithium bis(trifluoromethanesulfonyl)imide in a solvent of tetraglyme (tetraethylene glycol dimethyl ether) was used as the electrolytic solution.

### Example 4

Except for the preparation method of the electrolytic solution differing from Example 1, a coin-type battery of a non-aqueous solution system was obtained by performing the same operations as Example 1.

More specifically, an electrolytic solution prepared by dissolving 1.5 mol/L of lithium bis(trifluoromethanesulfonyl)imide in a solvent of tetraglyme (tetraethylene glycol dimethyl ether) was used as the electrolytic solution.

### Example 5

Except for the preparation method of the electrolytic solution differing from Example 1, a coin-type battery of a non-aqueous solution system was obtained by performing the same operations as Example 1.

More specifically, an electrolytic solution prepared by dissolving 2.0 mol/L of lithium bis(trifluoromethanesulfonyl)imide in a solvent of tetraglyme (tetraethylene glycol dimethyl ether) was used as the electrolytic solution.

### Example 6

Except for the preparation method of the electrolytic solution differing from Example 1, a coin-type battery of a non-aqueous solution system was obtained by performing the same operations as Example 1.

More specifically, an electrolytic solution prepared by dissolving 4.7 mol/L of lithium bis(trifluoromethanesulfonyl)imide in a solvent of tetraglyme (tetraethylene glycol dimethyl ether) was used as the electrolytic solution.

### Comparative Example 2

Except for the preparation method of the electrolytic solution differing from Example 1, a coin-type battery of a non-aqueous solution system was obtained by performing the same operations as Example 1.

More specifically, an electrolytic solution prepared by dissolving 1.0 mol/L of lithium bis(trifluoromethanesulfonyl)imide in a solvent of tetraglyme (tetraethylene glycol dimethyl ether) was used as the electrolytic solution.

### Charge-Discharge Cycle Test

A charge-discharge cycle test was implemented on the respective batteries prepared in Examples 3 to 6 and Comparative Example 2. The charge-discharge cycle test was conducted after leaving the battery immediately after prepared for 1 hour at room temperature.

More specifically, inside a thermostatic bath maintained at 25° C.±2° C., it was discharged to 1.5 V at a constant current of 0.1 mA, after charging until 4.0 V at a constant current of 0.1 mA. Then, this was defined as one cycle, and the discharge capacity density (mAh/g) per mass of the cathode active material (rubeanic acid) in each cycle was measured when repeating this operation. The results thereof are shown in FIG. 4.

Herein, the horizontal axis in FIG. 4 represents the number of cycles, and the vertical axis represents the discharge capacity ratio when defining as 100 the capacity density (mAh/g) per mass of cathode active material (rubeanic acid) obtained when discharging the battery prepared in Comparative Example 2 (electrolytic solution concentration 1.0 mol/L) until 1.5 V at a constant current of 0.1 mA after charging to 4.0 V at a constant current of 0.1 mA for the first time under 25° C.±2° C., i.e. relative discharge capacity.

### Charge-Discharge Efficiency

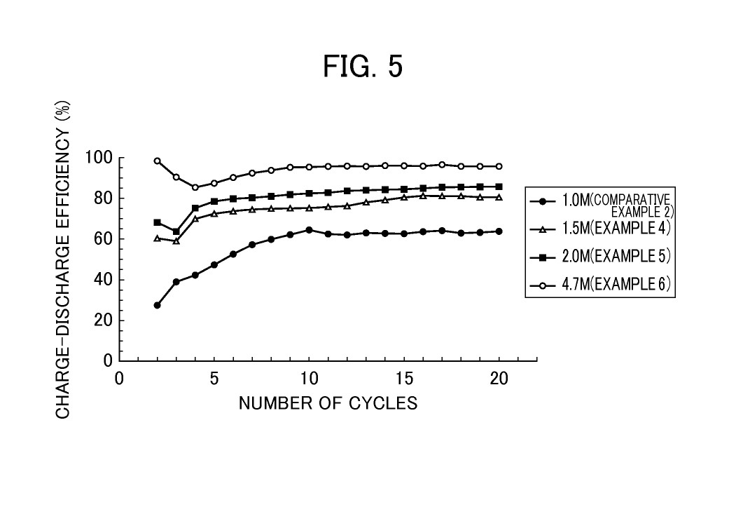

In addition, upon the batteries prepared in Examples 4 to 6 and Comparative Example 2 discharging to 1.5 V at a constant current of 0.1 mA after charging to 4.0 V at a constant current of 0.1 mA under 25° C.±2° C., the charge-discharge efficiency of the cathode active material (rubeanic acid) was measured in each cycle. The results thereof are shown in FIG. 5. Herein, the horizontal axis in FIG. 5 represents the number of cycles, and the vertical axis represents the percentage of the discharge capacity density (mAh/g) relative to the charge capacity density (mAh/g) per mass.

It was confirmed from FIG. 4 that the discharge capacity in each cycle of the batteries prepared in present Examples 3 to 6 are higher than the discharge capacity in each cycle of the battery prepared in Comparative Example 2.

It was confirmed from FIG. 5 that the charge-discharge efficiency in each cycle of the batteries prepared in present Examples 4 to 6 is higher than the charge-discharge efficiency in each cycle of the battery prepared in Comparative Example 2.

Herein, with the battery of Comparative Example 2 corresponding to the battery disclosed in Patent Document 1, it was confirmed from the above results that, according to the present invention, it is possible to provide a battery having high charge-discharge capacity density compared to conventionally, as well as having superior charge-discharge cycle properties and charge-discharge efficiency.

### EXPLANATION OF REFERENCE NUMERALS

1 battery
2 cathode
3 anode
4 separator

1. A battery including a cathode, an anode, and an electrolytic solution containing an electrolyte interposed between the cathode and the anode,
wherein the cathode comprises rubeanic acid or a rubeanic acid derivative as an active material; and
wherein a molar concentration of the electrolyte in the electrolytic solution is higher than 1.0 mol/L.

2. The battery according to claim 1, wherein the molar concentration of the electrolyte in the electrolytic solution is 1.5 to 4.7 mol/L.

3. The battery according to claim 1, wherein the molar concentration of the electrolyte in the electrolytic solution is 2.0 to 4.7 mol/L.

4. The battery according to claim 1, wherein the rubeanic acid or the rubeanic acid derivative has a structural unit represented by formula (1) below,
[Chem. 1]
—(NR¹—CS—CS—NR²)— (1)
where in R¹ and R² in formula (1) each independently represent a hydrogen atom, a halogen atom, a saturated linear hydrocarbon group, an unsaturated linear hydrocarbon group, a saturated cyclic hydrocarbon group, an unsaturated cyclic hydrocarbon group, a saturated heterocyclic group, an unsaturated heterocyclic group, an aromatic hydrocarbon group, an aromatic heterocyclic group, a carbonyl group, a carboxyl group, an amino group, an amide group, a hydroxyl group, a sulfide group, a disulfide group or a sulfone group.

5. The battery according to claim 1, wherein the rubeanic acid or the rubeanic acid derivative is represented by formula (2) below,
[Chem. 2]
R³—(NR¹—CS—CS—NR²)ₙ—R⁴ (2)
wherein R¹, R², R³ and R⁴ in formula (2) each independently represent a hydrogen atom, a halogen atom, a saturated linear hydrocarbon group, an unsaturated linear hydrocarbon group, a saturated cyclic hydrocarbon group, an unsaturated cyclic hydrocarbon group, a saturated heterocyclic group, an unsaturated heterocyclic group, an aromatic hydrocarbon group, an aromatic heterocyclic group, a carbonyl group, a carboxyl group, an amino group, an amide group, a hydroxyl group, a sulfide group, a disulfide group or a sulfone group; and n represents an integer of at least 1.

6. The battery according to claim 1, wherein the anion derived from the electrolyte is at least one type selected from the group consisting of PF₆⁻, AsF₆⁻, BF₄⁻, Cl⁻, Br⁻, ClO₄⁻, CH₃SO₃⁻, CF₃SO₃⁻, C₄F₉SO₃⁻, (CF₃SO₂)₂N⁻ and (CF₃SO₂)₃C⁻.
